(19) United States
(12) Patent Application Publication
(10) Pub. No.: US 2019/0370560 A1
(43) Pub. Date: Dec. 5, 2019

(54) DETECTING CHANGES IN OBJECT SIZE OVER LONG TIME SCALES

(71) Applicant: WIZR LLC, Santa Monica, CA (US)

(72) Inventors: Andrew PIERNO, Santa Monica, CA (US); David CARTER, Marina del Rey, CA (US); Genquan DUAN, Los Angeles, CA (US); Daniel MAZZELLA, Los Angeles, CA (US)

(73) Assignee: WIZR LLC, Santa Monica, CA (US)

(21) Appl. No.: 16/408,236

(22) Filed: May 9, 2019

Related U.S. Application Data
(60) Provisional application No. 62/668,928, filed on May 9, 2018.

(51) Int. Cl. G06K 9/00; G06T 7/60

(52) U.S. Cl. CPC G06K 9/00765; G06T 2207/10016; G06T 7/60

(57) ABSTRACT

Changes in sizes of objects over long periods of time are detected. The objects may be detected in the field of view of a camera that is used in systems having artificial intelligence engines in connection with video cameras and associated video data streams. A video processor identifies different elements in the video stream. Segments are created around the different elements identified. The video processor identifies an algorithm for each segment. An object is identified in the video stream. The video processor uses the created segments and the identified algorithms to detect changes in the object over time.

### BRIEF DESCRIPTION OF THE FIGURES

These and other features, aspects, and advantages of the present disclosure are better understood when the following Detailed Description is read with reference to the accompanying drawings.

FIG. 1 illustrates a block diagram of a system 100 for auto segmentation to derive object height for a video feed.

FIG. 2 is a flowchart of an example process for auto segmentation to derive object height for a video feed.

FIG. 3 shows an illustrative computational system for performing functionality to facilitate implementation of embodiments described herein.

### DETAILED DESCRIPTION

Systems and methods are disclosed for auto segmentation to derive object height for a video feed.

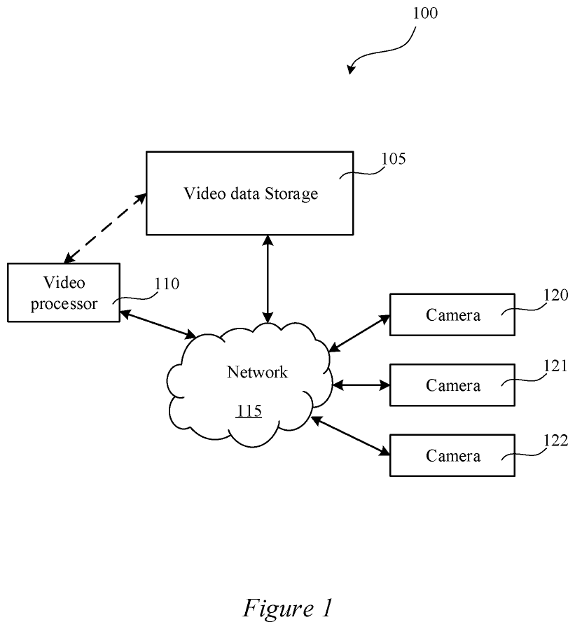

FIG. 1 illustrates a block diagram of a system 100 that may be used in various embodiments. The system 100 may include a plurality of cameras: camera 120, camera 121, and camera 122. While three cameras 120, 121, and 122 are shown, any number of cameras may be included. These cameras may include any type of video camera such as, for example, a wireless video camera, a black and white video camera, surveillance video camera, portable cameras, battery powered cameras, CCTV cameras, Wi-Fi enabled cameras, smartphones, smart devices, tablets, computers, GoPro cameras, wearable cameras, etc. The cameras may be positioned anywhere such as, for example, within the same geographic location, in separate geographic locations, positioned to record portions of the same scene, positioned to record different portions of the same scene, etc. In some embodiments, the cameras may be owned and/or operated by different users, organizations, companies, entities, etc.

The cameras may be coupled with the network 115. The network 115 may, for example, include the Internet, a telephonic network, a wireless telephone network, a 3G network, etc. In some embodiments, the network may include multiple networks, connections, servers, switches, routers, connections, etc. that may enable the transfer of data. In some embodiments, the network 115 may be or may include the Internet. In some embodiments, the network may include one or more LAN, WAN, WLAN, MAN, SAN, PAN, EPN, and/or VPN.

In some embodiments, one more of the cameras may be coupled with a base station, digital video recorder, or a controller that is then coupled with the network 115.

The system 100 may also include video data storage 105 and/or a video processor 110. In some embodiments, the video data storage 105 and the video processor 110 may be coupled together via a dedicated communication channel that is separate than or part of the network 115. In some embodiments, the video data storage 105 and the video processor 110 may share data via the network 115. In some embodiments, the video data storage 105 and the video processor 110 may be part of the same system or systems.

In some embodiments, the video data storage 105 may include one or more remote or local data storage locations such as, for example, a cloud storage location, a remote storage location, etc.

In some embodiments, the video data storage 105 may store video files recorded by one or more of camera 120, camera 121, and camera 122. In some embodiments, the video files may be stored in any video format such as, for example, mpeg, avi, etc. In some embodiments, video files from the cameras may be transferred to the video data storage 105 using any data transfer protocol such as, for example, HTTP live streaming (HLS), real time streaming protocol (RTSP), Real Time Messaging Protocol (RTMP), HTTP Dynamic Streaming (HDS), Smooth Streaming, Dynamic Streaming over HTTP, HTML5, Shoutcast, etc.

In some embodiments, the video data storage 105 may store user identified event data reported by one or more individuals. The user identified event data may be used, for example, to train the video processor 110 to capture feature events.

In some embodiments, a video file may be recorded and stored in memory located at a user location prior to being transmitted to the video data storage 105. In some embodiments, a video file may be recorded by the camera and streamed directly to the video data storage 105.

In some embodiments, the video processor 110 may include one or more local and/or remote servers that may be used to perform data processing on videos stored in the video data storage 105. In some embodiments, the video processor 110 may execute one more algorithms on one or more video files stored with the video storage location. In some embodiments, the video processor 110 may execute a plurality of algorithms in parallel on a plurality of video files stored within the video data storage 105. In some embodiments, the video processor 110 may include a plurality of processors (or servers) that each execute one or more algorithms on one or more video files stored in video data storage 105. In some embodiments, the video processor 110 may include one or more of the components of computational system 400 shown in FIG. 4.

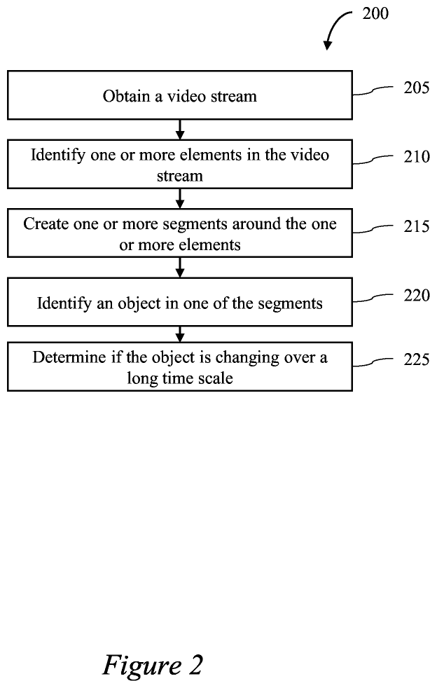

FIG. 2 is a flowchart of an example process 200 for auto segmentation to derive object height. One or more steps of the process 200 may be implemented, in some embodiments, by one or more components of system 100 of FIG. 1, such as video processor 110. Although illustrated as discrete blocks, various blocks may be divided into additional blocks, combined into fewer blocks, or eliminated, depending on the desired implementation.

Process 200 may begin at block 205. At block 205 the system 100 may obtain a video stream. In some embodiments, the video stream may be a video stream for a camera such as, for example, camera 120, camera 121, and/or camera 122. The video stream, for example, may be received as an mjpeg video stream, h264 video stream, VP8 video stream, MP4, FLV, WebM, ASF, ISMA, flash, HTTP Live Streaming, etc. Various other streaming formats and/or protocols may be used.

In some embodiments, at block 210 the video processor 110 may identify different elements in the video stream. For example, the video processor 110 may identify elements in a single frame of the video stream and/or may identify elements in multiple frames of the video stream. For example, elements of the video stream associated with the sky may be identified. In some embodiments, elements of the video stream associated with windows, a home, a pool, and/or vegetation may be identified. In some embodiments, elements of the video stream associated with a building may be identified. In some embodiments, processing individual video frames rather than a video clip or video file may be less time consuming and/or less resource demanding. In some embodiments, the elements may be identified based on elements that were identified for other cameras and/or video feeds.

At block 215 segments may be created around the different elements identified at block 210. In some embodiments, segments may not be created around some elements identified at block 210. Alternatively or additionally, in some embodiments multiple segments may include at least one element identified at block 210 in common. In some embodiments, the combination of all of the segments created may not cover the entire video stream and/or the entire image of the video stream. In some embodiments, some of the segments created may overlap. Video processor 110 may create segments around the different elements. In some embodiments, segments may be created based on segments that were created for other cameras and/or video feeds.

In some embodiments, the video processor 110 may identify a different algorithm for each segment. The algorithm for each segment may be configured to identify objects of interest in the segment. Additionally or alternatively, the algorithm for each segment may be adapted to efficiently analyze the video for each segment. In some embodiments, the algorithm identified for each segment may be based on a database of segments and algorithms. For example, in some embodiments, the video processor 110 may store a description of a segment together with an algorithm that is used with that segment. After creating a new segment, the video processor 110 may compare the new segment with the segments in the database. Based on the comparison of the new segment with the segments in the database, the video processor 110 may select an algorithm that corresponds with a segment that is similar to the new segment. The similarity of segments may be determined by evaluating a scene structure and a camera view in the video stream.

In some embodiments, the one or more segments may be associated with similar elements of the video stream. For example, one segment of the video stream may be generated around the sky. Another segment of the video stream may be generated around one or more buildings. Other segments may be generated around a body of water, windows, vegetation, or other elements of the video stream. For example, the video processor 110 may create a segment around a building.

In some embodiments, at block 220 the video processor 110 may identify an object in the video stream. In some embodiments, the video processor 110 may identify an object by using an image identification algorithm. In these and other embodiments, the object may include a building or a tower. In these and other embodiments, the video processor 110 may select a snapshot with one or more moving objects. For example, the video processor 110 may determine that between a first frame and a second frame, pixels associated with one or more objects in the video stream have moved. In some embodiments, some frames of the video stream may not include the object. For example, prior to the start of construction of a building, frames of the video stream may not include the building. After construction of the building has started, later frames of the video stream may include the building.

In some embodiments, at block 225 the video processor 110 may determine if the object is changing over a long time scale. For example, in some embodiments an object may change slowly over time. For example, a building may be built up over a matter of weeks, months, and/or years. In these and other embodiments, the object may not appear to be moving. In these and other embodiments, no changes in the object may exist between adjacent frames in the video stream. In these and other embodiments, no changes or only minor changes may exist between frames of one day and frames of a subsequent day. In some embodiments, the video processor 110 may determine if there are high-level shape and architecture changes in the object over time. For example, changes to the shape or the height of the object may be identified. In these and other embodiments, the video processor 110 may ignore changes primarily related to the aesthetics of the building such as, for example, color changes and illumination changes. Additionally or alternatively, in some embodiments, changes that do not affect the height of the building may also be ignored. For example, the presence of shutters, banners, window cleaning crews, and other elements may be ignored.

In some embodiments, the video processor 110 may also determine a height for the object. For example, in some embodiments, the video processor may compare the height of the object with the heights of other objects. By comparing the relative heights of the object, the video processor 110 may be able to generate an absolute height for the object.

In some embodiments, the video processor 110 may also obtain geographic and/or topographic information for the location where the video stream and/or the object is located. For example, in some embodiments, the video stream may be generated by a camera 120. The video processor 110 may obtain a latitude and a longitude for the camera. In some embodiments, the video processor 110 may obtain a direction the camera 120 is facing. In some embodiments, the geographic information may be a map of the area. Alternatively or additionally, in some embodiments, the video processor 110 may obtain a top-down image of the area where the video stream is, such as a satellite image of the location of the video stream and the location of the object. By using the geographic and/or topographic information together with the video stream, the video processor 110 may be able to generate a height of the object and/or determine whether the object is changing over time.

In some embodiments, the video stream may be changing over time while the object may not be changing. For example, in some embodiments, the source of the video stream may be a camera 120. In these and other embodiments, the camera 120 may be drooping from its original position. For example, the camera 120 may start to tilt downwards. As a result, the object may appear to grow taller as the camera 120 tilts downwards. By comparing the object with other objects in the video stream and/or by comparing successive images of the video stream to each other, the video processor 110 may be able to identify that the object has not changed and that instead the video stream position and/or angle is changing.

One skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments. For example, in some embodiments, the process 200 may further include providing an alert to a user regarding the changes to the object. For example, in some embodiments, the process 200 may include providing a message to the user with a summary video of the changes to the object. In these and other embodiments, the message may include information on the changes to the building, indicating to the user the rate at which the building is changing or being constructed. In these and other embodiments, the summary video may include several frames from the video stream to show the change in the object. As described above, the change to the object may occur over a long period of time. Thus, the summary video may include frames from a similarly long period of time to show in an abbreviated manner the changes to the object. For example, a summary video may include frames from a span of years, months, weeks, days, hours, or minutes and may be a video with a duration of a few minutes, a few seconds, or any other duration. For example, in some embodiments, the summary video may include less than ten frames and the ten frames may cover a span of one month.

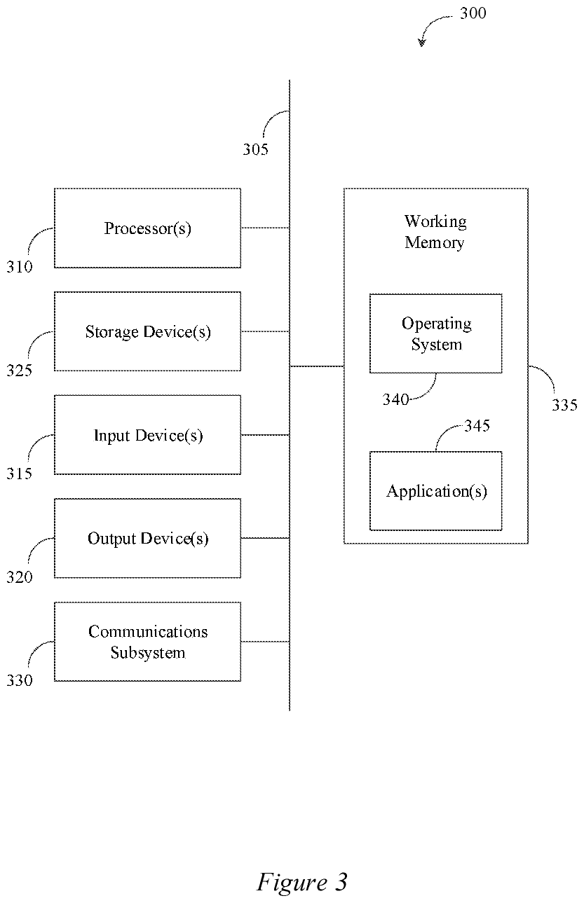

The computational system 300 (or processing unit) illustrated in FIG. 3 can be used to perform and/or control operation of any of the embodiments described herein. For example, the computational system 300 can be used alone or in conjunction with other components. As another example, the computational system 300 can be used to perform any calculation, solve any equation, perform any identification, and/or make any determination described here.

The computational system 300 may include any or all of the hardware elements shown in the figure and described herein. The computational system 300 may include hardware elements that can be electrically coupled via a bus 305 (or may otherwise be in communication, as appropriate). The hardware elements can include one or more processors 310, including, without limitation, one or more general-purpose processors and/or one or more special-purpose processors (such as digital signal processing chips, graphics acceleration chips, and/or the like); one or more input devices 315, which can include, without limitation, a mouse, a keyboard, and/or the like; and one or more output devices 320, which can include, without limitation, a display device, a printer, and/or the like.

The computational system 300 may further include (and/or be in communication with) one or more storage devices 325, which can include, without limitation, local and/or network-accessible storage and/or can include, without limitation, a disk drive, a drive array, an optical storage device, a solid-state storage device, such as random access memory (“RAM”) and/or read-only memory (“ROM”), which can be programmable, flash-updateable, and/or the like. The computational system 300 might also include a communications subsystem 330, which can include, without limitation, a modem, a network card (wireless or wired), an infrared communication device, a wireless communication device, and/or chipset (such as a Bluetooth® device, a 802.6 device, a Wi-Fi device, a WiMAX device, cellular communication facilities, etc.), and/or the like. The communications subsystem 330 may permit data to be exchanged with a network (such as the network described below, to name one example) and/or any other devices described herein. In many embodiments, the computational system 300 will further include a working memory 335, which can include a RAM or ROM device, as described above.

The computational system 300 also can include software elements, shown as being currently located within the working memory 335, including an operating system 330 and/or other code, such as one or more application programs 345, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 325 described above.

In some cases, the storage medium might be incorporated within the computational system 300 or in communication with the computational system 300. In other embodiments, the storage medium might be separate from the computational system 300 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 300 and/or might take the form of source and/or installable code, which, upon compilation and/or installation on the computational system 300 (e.g., using any of a variety of generally available compilers, installation programs, compression/decompression utilities, etc.), then takes the form of executable code.

Various embodiments are disclosed. The various embodiments may be partially or completely combined to produce other embodiments.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for-purposes of example rather than limitation, and does not preclude inclusion of such modifications, variations, and/or additions to the present subject matter as would be readily apparent to one of ordinary skill in the art.

1.-3. (canceled)

4. A method for auto segmentation to derive object height, the method comprising:
obtaining a video stream;
identifying one or more elements in the video stream;
creating one or more segments around the one or more elements;
identifying an object in one of the segments; and
determining if the object is changing over a long time scale.
